(19) United States
(12) Patent Application Publication
(10) Pub. No.: US 2023/0360531 A1
(43) Pub. Date: Nov. 9, 2023

(54) SYSTEM AND METHOD FOR ADAPTIVE V2X APPLICATIONS

(71) Applicant: AUTOTALKS LTD., Kfar Netter (IL)

(72) Inventor: Ohad Ashery Bonaventura, Kfar Netter (IL)

(21) Appl. No.: 17/739,096

(22) Filed: May 7, 2022

(51) Int. Cl. G08G 1/16; H04W 4/40

(52) U.S. Cl. CPC G08G 1/162; H04W 4/40; G07C 5/008

(57) ABSTRACT

A system and method of use, the system including: a vehicle-to-everything (V2X) module installed in a vehicle and including a V2X application running thereon wherein the V2X application is configured to generate or suppress an alert; and a traffic rule server (TRS) in data communication with the V2X module, wherein the TRS is configured to collect event data from the V2X module related to the generated or suppressed alert, the event data including an event location, and is further configured to determine whether the generated or suppressed alert was a false positive (FP), false negative (FN), or true positive (TP) alert, and to create a rule for use in a V2X application receiving the rule, the rule used for reducing FP and FN alerts generated or suppressed in the proximity of the event location by the V2X application receiving the rule.

### FIELD

Embodiments disclosed herein relate generally to systems and methods for V2X applications and more specifically enhancing the accuracy of such V2X applications.

### BACKGROUND

V2X (vehicle-to-everything) applications may collect and analyze an ego-vehicle's state parameters as well as the state parameters of other nearby road participants (herein “remote vehicles”), broadcast in state messages by those remote vehicles. In this context, a vehicle's state parameters may include the vehicle's location, speed, heading, longitudinal/lateral acceleration, braking and turn signals. V2X applications may use collected state parameters in order to predict a potential collision. Once a potential collision has been determined by the V2X application, the V2X application may generate a collision alert (also referred to herein simply as “alert” or “signal”) to a driver or higher layer application such as advanced driver-assistance systems (ADAS). Alternatively, the V2X application may suppress the determined collision alert.

The decision by the V2X application to generate or suppress an alert may be based on a “collision confidence threshold” (also termed “confidence threshold” herein), i.e. a level of confidence in the validity of the collision alert, above which confidence threshold the collision alert will be generated, and below which the collision alert will be suppressed. Alerts may thus be either generated or suppressed and be categorized as follows: True-Positive (TP): a collision alert generated that is followed by either a collision, or driver preventive measures; False-Positive (FP): a collision alert generated that is not followed by a collision, or driver preventive measures or any change of the ego or remote vehicles' predicted paths; and False-Negative (FN): a collision alert suppressed that is followed by either a collision, or driver preventive measures, and/or an alert from another sensor. A collision alert that accurately predicts a collision but is issued too late and doesn't leave enough time to prevent the collision may also be considered a form of FN.

V2X applications may be prone to errors, mainly as a result of the following four factors: (1) insufficient accuracy of vehicle state parameters, most specifically position; (2) a time difference between the reception of state messages from multiple remote vehicles, mainly in congested conditions; (3) unpredictability of driver behavior and driver response times to changing road conditions; and (4) an unavailability of road layout and environmental conditions. The result of these errors may be a non-negligible rate of false-positives or false-negatives, both of which reduce the effectiveness of V2X technology and its potential to improve road safety.

The confidence threshold may be derived from factors (1) and (2) above, namely, the accumulated (estimated) errors of vehicle state parameters, as well as the time elapsed since the last received state message from remote vehicles. However, current V2X applications may not adequately consider factors (3) and (4) when defining the confidence threshold. Further, a low confidence threshold would raise the FP alert rate, and a high confidence threshold would raise the FN alert rate. Thus, setting the confidence threshold, and balancing the FP and FN rates is one of the main design challenges of V2X applications.

It would therefore be desirable to reduce the rate of FPs/FNs by adapting V2X applications and confidence thresholds to the specific conditions in which the vehicle is traveling while potentially considering factors (3) and (4) above.

### SUMMARY

Embodiments disclosed include systems and methods for enhanced V2X applications. The system and methods disclosed herein aim to reduce the rate of FPs/FNs generated by V2X applications by, for example, adapting the V2X applications and confidence thresholds to the specific conditions in which the vehicle is traveling while potentially considering, amongst other factors, driver behavior, driver response times, actual road layouts and environmental conditions.

In use, V2X modules associated with vehicles may transmit event data from specific locations related to alerts issued from or suppressed by V2X applications to a central traffic rule server (TRS). The TRS may analyze the received data to determine the amounts of TPs, FPs, or FNs, and may define rules for the V2X applications including confidence thresholds and collision lead times such that the occurrence of FPs or FNs may be reduced, under (sufficiently) similar circumstances, for future vehicles arriving at the same location. These updated rules may then be provided to vehicles arriving at the same location such that the related V2X applications may function according to the updated rules.

V2X modules may be installed in vehicles and may be carried by pedestrians as well. As used herein the term “vehicle” (relating to an ego-vehicle or remote vehicle) may include but is not limited to cars, trucks, buses, motorcycles, bicycles, scooters, pedestrians, and so forth. A “driver” is the driver of a “vehicle” as defined herein and may include human as well as autonomous (computer controlled) driving systems in which the driver is the vehicle. A remote vehicle may be a vehicle that is within the environment of the ego-vehicle and may also be referred to herein as an “other” (or “another”) road user. As used herein, an alert may refer to an alert of a potential collision such that a driver (human or autonomous) may take evasive action to avoid the collision. Such an alert may be provided by audio, visual, or data means as provided by the hardware of the vehicle.

Consistent with disclosed embodiments, a system includes: a V2X module installed in a vehicle and including a V2X application running thereon wherein the V2X application is configured to generate or suppress an alert; and a TRS in data communication with the V2X module, wherein the TRS is configured to collect event data from the V2X module related to the generated or suppressed alert, the event data including an event location, and is further configured to determine whether the generated or suppressed alert was an FP, FN, or TP alert, and to create a rule for use in a V2X application receiving the rule, the rule used for reducing FP and FN alerts generated or suppressed in the proximity of the event location by the V2X application receiving the rule.

Consistent with disclosed embodiments, a system includes: a V2X module installed in a vehicle and including a V2X application running thereon wherein the V2X application is configured to generate or suppress an alert; and a TRS in data communication with the V2X module, wherein the TRS is configured to collect event data from the V2X module related to the generated or suppressed alert, and is further configured to determine whether the generated or suppressed alert was an FP, FN, or TP alert, and to create a rule for use in a V2X application receiving the rule, the rule used for reducing FP and FN alerts generated or suppressed by the V2X application receiving the rule.

In some embodiments, the V2X application receiving the rule is configured to receive the rule from the TRS and to adjust its generation or suppression of an alert according to the rule. In some embodiments, the rule includes a suggested collision confidence threshold (CCT) and/or a collision lead time (CLT). In some embodiments, the rule relates to one or more of an event location, an event time, an ego vehicle state, or a remote vehicle states.

In some embodiments, the event data is selected from the group consisting of an event location, an event time, an ego vehicle state, a remote vehicle state, a V2X alert generated, a V2X alert suppressed, a collision confidence level (CCL), a CLT, a CCT, and a combination thereof. In some embodiments, the event data includes data from a time when the alert was generated or suppressed until one timeslot after a predicted collision time.

In some embodiments, the TRS is configured to determine whether a collision occurred and/or whether preventive measures were taken by a driver based on one or both of the ego and the remote vehicle states. In some embodiments, the TRS is further configured to aggregate event data from a plurality of V2X applications according to an aggregation criteria.

In some embodiments, the aggregation criteria includes a location, a date, and/or a time. In some embodiments, the TRS is further configured to supplement the aggregated event data with supplemental data, and wherein the supplemental data is selected from the group consisting of high-definition maps including road and intersections layouts with lane level positioning, road conditions/obstructions, traffic data, weather data, visibility data, and a combination thereof.

Consistent with disclosed embodiments, a method includes: providing a V2X module installed in a vehicle and including a V2X application running thereon, wherein the V2X application is configured to generate or suppress an alert; providing a TRS in data communication with the V2X module; and using the TRS to collect event data from the V2X module related to the generated or suppressed alert, wherein the event data may include an event location, to determine whether the generated or suppressed alert was an FP, FN, or TP alert, and to create a rule for use in a V2X application receiving the rule, the rule used for reducing FP and FN alerts generated or suppressed by the V2X application receiving the rule.

In some embodiments, the rule relates to one or more of an event location, an event time, an ego vehicle state, or remote vehicle states. In some embodiments, the method further includes, providing a V2X application configured to receive the rule from the TRS and to adjust its generation or suppression of an alert according to the rule. In some embodiments, the rule includes a suggested CCT and/or a CLT.

In some embodiments, the event data is selected from the group consisting of an event location, an event time, an ego vehicle state, a remote vehicles' state, a V2X alert generated, a V2X alert suppressed, a CCL, a CCT, and a combination thereof.

In some embodiments, the event data includes data from a time when the alert was generated or suppressed, until one timeslot after a predicted collision time. In some embodiments, the TRS is further configured to aggregate event data from a plurality of V2X applications according to an aggregation criteria, and wherein the aggregation criteria includes a location, a date, and/or a time.

In some embodiments, the TRS is further configured to supplement the aggregated event data with supplemental data, and wherein the supplemental data is selected from the group of high-definition maps including road and intersections layouts with lane level positioning, road conditions/obstructions, traffic data, weather, visibility data, and a combination thereof.

Consistent with disclosed embodiments, a system, includes a TRS configured to analyze road and/or environmental data at a location and to create a rule for use in a V2X application receiving the rule, the rule used for reducing FP and FN alerts generated or suppressed in the proximity of the location by the V2X application receiving the rule. In some embodiments, the V2X application receiving the rule is configured to receive the rule from the TRS and to adjust its generation or suppression of an alert according to the rule. In some embodiments, road data includes high-definition maps including road and intersections layouts with lane level positioning, and environmental data is selected from the group consisting of road conditions/obstructions, traffic data, weather, visibility data, and a combination thereof.

Consistent with disclosed embodiments, a method includes providing a TRS; and using the TRS to analyze road and environmental data at a location and to create a rule for use in a V2X application receiving the rule, the rule used for reducing FP and FN alerts generated or suppressed in the proximity of the location by the V2X application receiving the rule. In some embodiments, road data includes high-definition maps including road and intersections layouts with lane level positioning, and environmental data is selected from the group consisting of road conditions/obstructions, traffic data, weather, visibility data, and a combination thereof.

In some embodiments, the method further includes, providing a V2X application configured to receive the rule from the TRS, and to adjust its generation or suppression of an alert according to the rule.

Consistent with disclosed embodiments, a non-transitory computer readable medium may contain instructions that when executed by at least one processor, cause the at least one processor to perform operations for reducing FP and FN alerts in a V2X application configured to generate or suppress an alert associated with an ego vehicle, the operations comprising: collecting event data related to the generated or suppressed alert; determining whether the generated or suppressed alert was an FP, FN, or TP alert; and creating a rule for reducing FP and FN alerts in a V2X application of the same or another ego vehicle in substantially the same situation in the future.

In some embodiments, the rule relates to one or more of event location, event time, ego vehicle state, and remote vehicle states. In some embodiments, a V2X application receiving the rule is configured to adjust its generation or suppression of an alert according to the received rule. In some embodiments, a rule includes a suggested CCT and/or CLT. In some embodiments, event data includes data from a time when a V2X alert was triggered until one timeslot after a predicted collision time. In some embodiments, the operations further include aggregating event data from a plurality of V2X applications according to an aggregation criteria, and wherein aggregation criteria may include a location, date, and/or time.

In some embodiments, the operations further include, supplementing aggregated event data with supplemental data, wherein supplemental data includes high-definition maps including road and intersections layouts with lane level positioning, road conditions/obstructions, traffic data, weather, and visibility data.

It should be appreciated that the examples provided herein relating to right-side driving environments may also be applied to left side driving environments with suitable modifications.

This Summary is provided to introduce a selection of concepts in a simplified form that are further described in the Detailed Description below. It may be understood that this Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals.

Elements in the drawings are not necessarily drawn to scale.

FIG. 1A illustrates a V2X application environment according to some implementations;

FIG. 1B illustrates schematically a block diagram of a V2X module according to some implementations;

FIG. 2 illustrates a flow chart of a process for enhancing V2X applications according to some implementations;

FIG. 3A illustrates a flow chart of a process for enhancing V2X applications according to some implementations;

FIGS. 3B-3D illustrate a process for enhancing V2X applications for the V2X application type Intersection-Movement-Assist (IMA) according to some implementations;

FIG. 4 illustrates a flow chart of a process for enhancing the accuracy of V2X applications according to some implementations;

FIG. 5 is an illustration of an exemplary road intersection where V2X applications may be enhanced according to some embodiments;

FIG. 6 is an illustration of an exemplary road intersection where V2X applications may be enhanced according to some embodiments; and

FIG. 7 is an illustration of an exemplary road intersection where V2X applications may be enhanced according to some embodiments.

### DETAILED DESCRIPTION

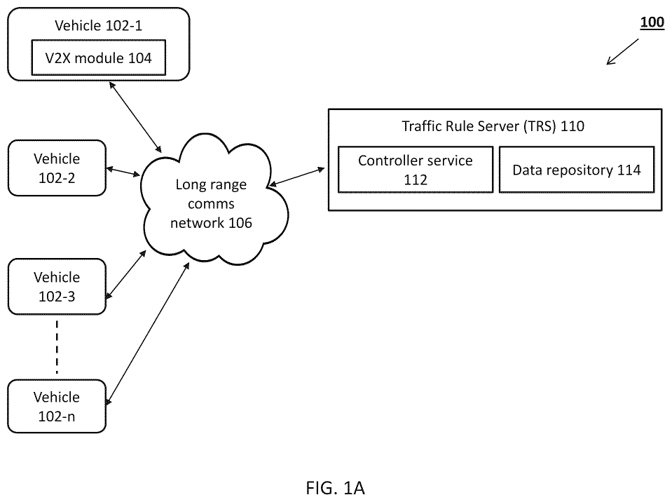

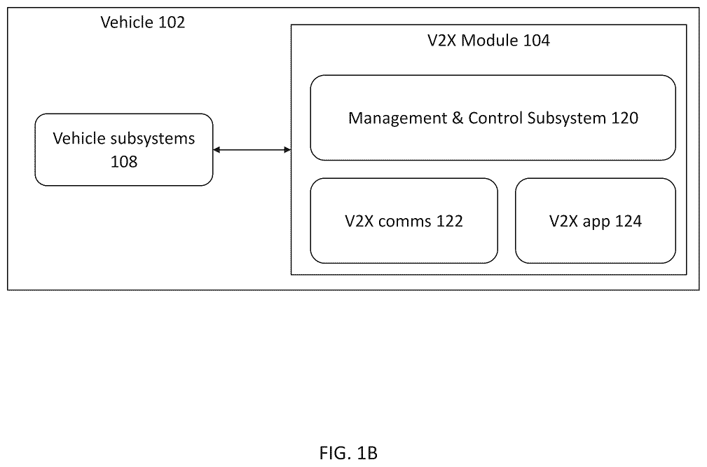

Embodiments disclosed herein provide for systems and methods for enhanced V2X applications. FIG. 1A illustrates a V2X application environment 100 according to some implementations including vehicles 102 that may have V2X modules 104 installed therein (shown here are four such vehicles 102-1 to 102-n). V2X modules 104 may be in short range communication with one another and may be in long range communication with a traffic rule server (TRS) 110 over a long-range wireless communications (comms) network 106. Communications network 106 may include a wide variety of network configurations and protocols that facilitate the intercommunication of computing devices.

FIG. 1B illustrates schematically a block diagram of a V2X module 104 according to some implementations. V2X module 104 is a computing device as defined herein. V2X module 104 may interface with vehicle 102, particularly with vehicle subsystems 108 that may include vehicle computing systems/sensors/ADAS.

V2X module 104 may include a management and control subsystem (MCS) 120. MCS 120 may manage the operation of the components of V2X module 104 and may direct the flow of data between the components of V2X module 104. Where V2X module 104 may be said herein to provide specific functionality or perform actions or processes, it should be understood that the functionality or actions are performed by MCS 110 that may perform the functionality or actions or may call on other components of V2X module 104 for performing functionality or actions. V2X module 104 and the modules and components that are included in V2X module 104 may include a non-transitory computer readable medium containing instructions that when executed by at least one processor are configured to perform the functions and/or operations necessary to provide the functionality described herein.

V2X module 104 components such as hardware and software modules may include a V2X comms unit 122, and one or more V2X applications 124. In some embodiments, the V2X application may generate alerts to the vehicle driver directly. In some embodiments, the V2X application may classify and filter remote vehicles according to their relevance to the ego vehicle's safety and forward this information to the vehicle's ADAS for processing along with data from other sensors. In some embodiments, V2X applications 124 are in data communication with TRS 110 for transmitting event data and for receiving relevant rules from TRS 110 when approaching an area.

V2X comms 122 connects V2X modules 104 of vehicles 102 that are part of V2X application environment 100 using wireless V2X communication. The number of vehicles 102 shown in FIG. 1A is illustrative and it should be appreciated that V2X application environment 100 may include any relevant number of vehicles 102 having V2X modules 104 communicating simultaneously.

“V2X communications” as used herein refers to use of V2X (also known as “car to everything” or C2X) standards, protocols and frequencies adapted for use in V2X application environment 100 as described herein. V2X comms 122 may include a modem (not shown), a communication stack (not shown) and means to transmit wirelessly utilizing the V2X frequency band (such as antenna, RF, TX, and RX chains, etc.). V2X comms 122 may use IEEE802.11p or 3GPP C-V2X PC5 or other V2X standards for communication. The V2X communication stack may be adapted to support the V2X application functionality as described herein:

TRS 110 and the modules and components that are included in TRS 110 may run on a single computing device (e.g., a server) or multiple computing devices (e.g., multiple servers) that are configured to perform the functions and/or operations necessary to provide the functionality described herein. While TRS 110 is presented herein with specific components and modules, it should be understood by one skilled in the art, that the architectural configuration of system 100 as shown may be simply one possible configuration and that other configurations with more or fewer components are possible. As referred to herein, the “components” of TRS 110 may include one or more of the modules or services shown in FIG. 1A as being included within TRS 110.

TRS 110 may include a controller service 112. Controller service 112 may manage the operation of the components of TRS 110 and may direct the flow of data between the components of TRS 110 and also the communications and interactions with V2X modules 104. Where TRS 110 may be said herein to provide specific functionality or perform actions, it should be understood that the functionality or actions are performed by controller service 112 that may call on other components of TRS 110. TRS 110 and the modules and components that are included in TRS 110 may include a non-transitory computer readable medium containing instructions that when executed by at least one processor are configured to perform the functions and/or operations necessary to provide the functionality described herein.

TRS 110 may include a data repository 114. Although data repository 114 is shown as a single entity, in practice data repository 114 may include one or more databases. Data repository stores data required for the functioning of TRS 110.

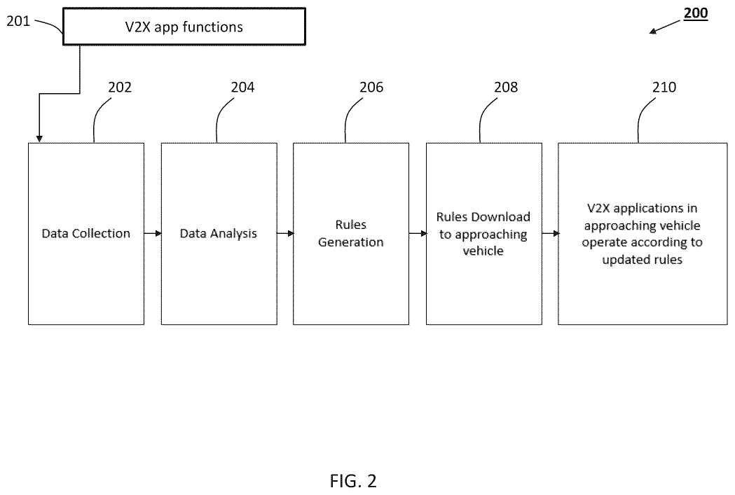

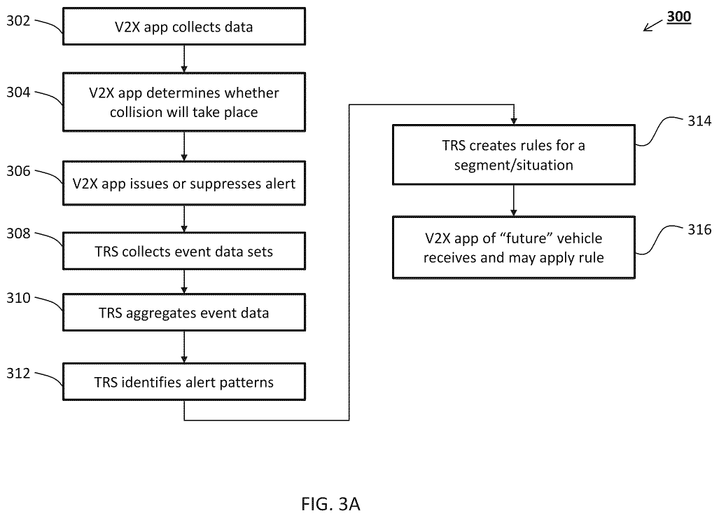

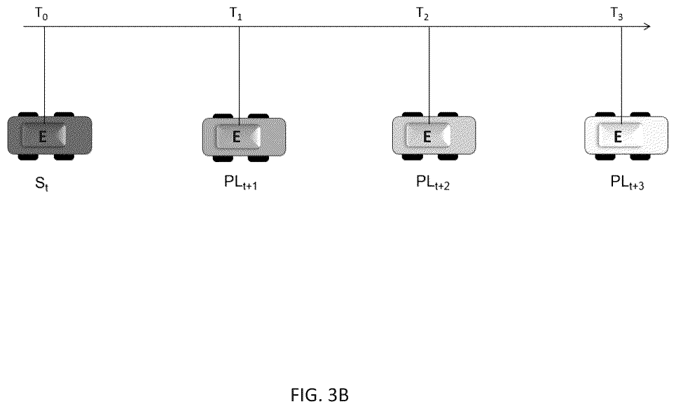

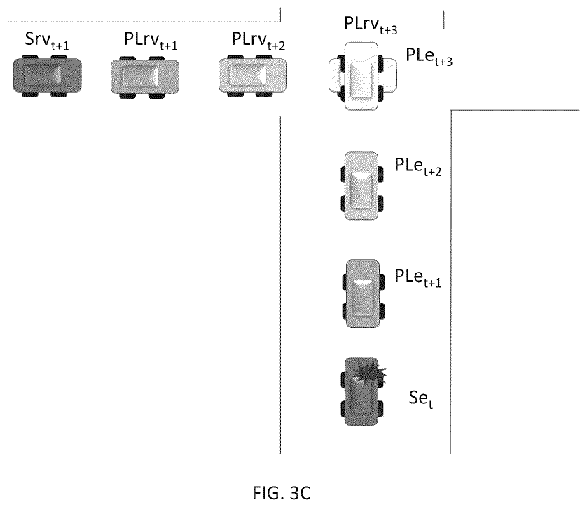

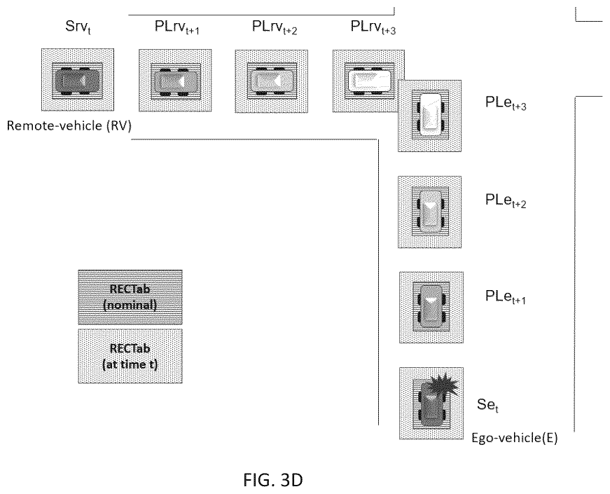

FIG. 2 illustrates a flow chart of a process 200 for enhancing V2X applications according to some implementations. Process 200 is described further below in more detail with reference to FIG. 3A. Process 200 may be performed by TRS 110 and V2X modules (such as V2X modules 104 described above) in communication with one another. A non-transitory computer readable medium may contain instructions that when executed by at least one processor performs the operations described at each step in process 200. The non-transitory computer readable medium and at least one processor may correspond to TRS 110 and/or V2X module 104.

In step 201, the V2X application performs its intended function, monitoring data from the ego and other vehicles and determining whether to issue or suppress alerts for a predicted event. In step 202, data from V2X applications may be collected and stored by the TRS. In some embodiments, the V2X applications may be configured to transmit event data to the TRS. In this step, vehicles traveling through a specific location (intersection or road segment) may upload event data to the TRS, including but not limited to event location, event time (where “time” includes one or more of date, day and time of day), ego-vehicle state, remote vehicle states, V2X alerts generated, V2X alerts suppressed (due to not passing the CCT), CCL, CLT, and CCT. In some embodiments, the ego vehicle state may include the ego vehicle location and/or time. In some embodiments, the ego vehicle state may include data (such as but not limited to location, speed, heading, acceleration/braking, steering/yaw, etc.) that enables determination by the TRS of the ego driver actions, and the remote vehicle state may include data that enables determination by the TRS of remote driver actions.

In some embodiments, event data may cover a period from when the application began determining whether to issue or suppress an alert to at least several seconds after the determined event was due to occur. In some embodiments, vehicle states (ego and remote) that are part of an event may cover a period of time and thus include a collection of vehicle states that may be collected periodically at collection timeslots (typically every 100 ms) from time 0 to time N+1, where time 0 is the time of the alert triggering (or suppression, if the alert did not pass CCT) and time N+1 is one collection timeslot after the predicted collision time.

In step 204 the collected event data may be analyzed by the TRS in order to identify TPs/FPs/FNs and also FP/FN alert patterns. The analysis may identify FPs as alerts that were generated but ignored by the driver(s) without any adverse consequences, and identify FNs as alerts that were suppressed (did not pass the CCT), but one or more of the following occurred: a collision, an alert generated by other sensors (such as but not limited to cameras or radar that are in communication with the V2X module), and/or harsh, preventive actions taken by drivers. FNs may also include an accurate V2X alert that was generated too late and did not allow the driver ample time to react safely.

In step 206 rules may be defined by the TRS to eliminate or reduce FPs or FNs under (sufficiently) similar circumstances for vehicles arriving at the same location in the future. For example, based on the analysis, if an FP was likely (in a particular scenario), the CCT would be increased whereas if an FN was likely, the CCT would be decreased. A non-limiting example of a rule may state: if the ego-vehicle's state (S) is Sₑ and the states of remote-vehicles 1 . . . m are Sᵣ1 . . . Sᵣₘ, then the CCT should be set to CCT_{%} and CLT should be set to CLT_{sec} where a vehicle's state (S) is defined as a set of parameters {S₁, S₂, . . . Sₙ} and a corresponding set of confidence levels {C₁, C₂, . . . Cₙ}.

In step 208 the relevant rules, generated in step 206, may be transmitted by the TRS to vehicles approaching or in the proximity of the location associated with the rule.

In step 210 V2X applications that have received the rules on an ego-vehicle that is approaching or in the proximity of the location for which the rule(s) were generated, may adapt their behavior according to the relevant rules. As part of step 210, the V2X application may determine that its current situation is sufficiently similar to that of the rule by performing one or more of the following steps/comparisons: compare the location with the location of the rule, compare the time (where “time” includes one or more of date, day and time of day) with the time of the rule, compare the ego-vehicle's state to the rule's ego-vehicle's state to determine whether the states match, within some tolerance level; compare the remote vehicles' states to the rule's remote vehicles' states to determine whether the states match within some tolerance level, and having thus determined that a rule is relevant (where, for example, the location, time, and ego and remote vehicle states are determined to match within the defined tolerance levels), set the CCT and CLT to the values defined in the rule and issue or suppress an alert accordingly to thereby enhance the accuracy of the V2X application.

FIG. 3A illustrates a flow chart of a process 300 for enhancing the accuracy of V2X applications according to some implementations. FIGS. 3B-3D illustrate process 300 for the V2X application type Intersection-Movement-Assist (IMA) according to some implementations. It should be appreciated that processes 200 and 300 may be equally applied to other V2X applications. A non-transitory computer readable medium may contain instructions that when executed by at least one processor performs the method and operations described at each step in process 300. The non-transitory computer readable medium and at least one processor may correspond to TRS 110 and/or V2X module 104. Where process 300 refers to operation of a TRS or a V2X module, this should be understood as referring to operation of the components of TRS 110 or V2X module 104.

In step 302, the V2X application may perform its intended function, in this case IMA for warning about potential collisions. The present non-limiting example is for an operation model of a V2X application on an ego-vehicle. As part of step 302, the V2X IMA application may take into account the following state parameters collected from the ego-vehicle and from remote vehicles:
Current time: t₀
Ego-vehicle (E) state: Se
Remote-vehicles (RV_{0 . . . n}) states: Sr_{0 . . . n}, For simplicity, a single remote vehicle RV will be considered with state Srv.

In step 304, the V2X application may determine whether a collision might take place. For each time t₀ the V2X application generates the predicted path (PP) for vehicle E and vehicle RV, based on the corresponding vehicle states collected. PP is defined as a series of Predicted Locations (PL), per each future timeslot {PLₜ₊₁, PLₜ₊₂ . . . }. A typical timeslot is 100 ms, however, for simplicity a timeslot of 1 sec will be considered. FIG. 3B shows an illustration of a PP for vehicle E for three future timeslots t₁, t₂, t₃ representing 3 future seconds with respect to t₀.

Hence, as shown in FIG. 3C, the predicted paths of E and RV would be {PLeₜ₁, PLeₜ₂, PLₑₜ₃}, and {PLrvₜ₁, PLrvₜ₂, PLrvₜ₃} and a collision may be predicted at time t₀, if at any time tᵢ, PLeₜᵢ is equal to PLrvₜᵢ.

The determination of step 304 may be further enhanced by accounting for vehicle dimensions and the precision of the received vehicle state as shown in FIG. 3D. In some implementations, PL may be defined as the center of a rectangle, with sides a and b, corresponding to the lateral and longitudinal axes of the vehicle's motion vector—RECT_{ab}(PL). The values of a and b take into account two factors: (1) the vehicle dimensions (with some fixed safety margins) —referred to as the nominal size of RECT_{ab}, and (2) the confidence (error) level of the vehicle state defining the actual size of RECT_{ab}. Accounting for RECT_{ab}, the collision prediction condition may be adjusted to: a collision is predicted at time t₀ if at any time tᵢ: RECT_{ab}(PLeₜᵢ) intersects RECT_{ab}(PLrvₜᵢ).

The CLT is defined as (tᵢ−t₀) and is intended to provide the driver (human, or machine) ample time t₀ safely react and apply preventive measures. A typical CLT, in case of a human driver, is 3 seconds, that is if at time to, a collision is predicted at t₃, then an alert should be raised at t₀.

The collision prediction may be indicated as {tᵢ, RV, CCL}, where tᵢ is the predicted collision time (relative to t₀), RV is the remote vehicle with which the collision is predicted, and CCL is the collision confidence level assigned to the collision. The CCT is the confidence threshold above which an alert will be generated (to the human driver or machine) and below which it will be suppressed. Following prediction of a collision, in step 306, the V2X application either issues an alert or suppresses an alert related to the predicted collision. Each such prediction, whether resulting in an alert or not is herein termed an “event” and the data collected by each vehicle is “event data”. In some embodiments, event data includes data collected up till at least one timeslot after the event. Although an ego vehicle and an RV may be part of the same potential collision, the event data of each of the ego vehicle and the RV will be different as the event occurs from each vehicle's perspective.

In step 308, event data may be collected by the TRS. In this step, V2X modules of vehicle traveling through a specific location (intersection or road segment) may upload event data to the TRS. In some implementations, the TRS may periodically request event data from V2X modules. Event data may include event location, event date, event time, alert parameters {tᵢ, RV, CCL} and CCT, and ego and remote vehicle states between t₀ and tᵢ₊₁ (one slot after the predicted collision). The ego and remote vehicle states may include parameters from which it can be determined by the TRS whether a collision occurred, and/or whether preventive measures were taken by the driver such as but not limited to abrupt braking and/or steering, and data from other sensors (such as but not limited to cameras or radar that are in communication with the V2X module) if available.

In step 310, the TRS may aggregate event data based on event data from each ego-vehicle that participated in an event to thereby form aggregated event data. Additionally or alternatively, in some embodiments, event data from multiple separate events and multiple vehicles taking place over a period of time may be aggregated according to an aggregation criteria such as but not limited to a location where the event occurred, date, time, and/or a combination of these to form aggregated event data. In some embodiments, a location where a significant number of events have occurred may be designated by an operator of the TRS as an Area of Interest (AOI) and event data may be aggregated for an AOI. Typically, an AOI may be a location such as an intersection, or a road segment with some physical characteristics that increases the likelihood for events (e.g., a curve with limited visibility). In some embodiments, events may be aggregated based on a Time of Interest (TOI) such as but not limited to times of increased traffic congestion or time of reduced/difficult lighting conditions (day, night, driving towards the sun, etc.).

In some embodiments, aggregated event data may include but is not limited to the following fields: a road segment ID or other location indicator, physical coordinates of the location (center of the road segment), road segment dimensions such as the segment length and width, segment heading such as a compass direction defining the heading of the segment, segment type/description (for example a lane merging into an intersection), a listing of events generated by ego-vehicles in the segment, event CCL, event CCT, event CLT, event date and time-of-day, and vehicle states including those of the ego vehicle and states of RVs that directly impacted each event.

In some embodiments, the TRS may supplement event data or aggregated event data with supplemental data available from non-V2X sources of data. Such supplemental data includes but is not limited to high-definition maps providing road and intersection layouts, that may include exact (lane level) positioning, road conditions/obstructions, real-time traffic data, weather, and visibility data. Supplemental data may enable generation of more accurate and effective rules (step 314). The Examples provided below illustrate use of such supplemental data.

In step 312, the aggregated event data (and supplemental data, if provided) may be analyzed and classified by the TRS, according to event types (TP/FP/FN). The analysis may identify FPs as alerts that were generated but ignored by the driver(s) without any adverse consequences and identify FNs as alerts that were suppressed (did not pass the CCT), but one of the following occurred: a collision, an alert generated by other sensors, and/or harsh, preventive actions taken by drivers. FNs may also include an accurate V2X alert that was generated too late and did not allow the driver ample time to react safely. In some embodiments, the analysis identifies FP/FN alert patterns such as but not limited to road segments where FPs or FNs are common.

In step 314 rules may be defined by the TRS to eliminate or reduce FPs or FNs under (sufficiently) similar circumstances for vehicles arriving at or in proximity to the same location in the future. Rules may be generated where aggregated event data shows a significant bias towards a single type of event such as but not limited to intersections where FPs or FNs are common. In this context, a significant bias may be defined as a percentage of events of a certain type that is above some predefined threshold.

As a non-limiting example, a rule may have the following structure/fields: Road segment identifier (or other location identifier), date, and time-range in which this rule should be applied, vehicle states for the ego and relevant RVs, suggested action i.e.: issue or suppress predicted collision alert, increase/decrease CCT to change the sensitivity level of alert generation, and/or increase/decrease CLT to change the lead time for collision detection.

Vehicle states (both of the ego and the RVs) indicated in the rule, may represent the weighted averages of vehicle states that are part of the aggregated event data. In a non-limiting example, if 100 FP events were determined for a certain road segment, each of these would be derived from one of 100 sets of event data each consisting of ego and RV vehicle states. The corresponding rule may include the weighted average of these 100 sets of event data. In such an averaging calculation, the weight of each event data would correspond to the CCL of the event it generated. Hence, an FP event that was generated with very high CCL, would impact the vehicles' states in the rule more than an FP event that was generated with a low CCL.

The ‘suggested action’ field in the rule may serves as a suggestion to a V2X application that has received the rule on an ego-vehicle entering or in proximity to the rule location, and may cause the V2X application to suppress altogether or ‘weaken’ the alert, in case of an FP, or ‘strengthen’ the alert in case of a TP/FN. In this context, ‘weakening’ is achieved by increasing the CCT and/or by reducing the CLT, whereas ‘strengthening’ is achieved by reducing the CCT and/or increasing the CLT.

In step 316 the relevant rules, generated in step 314, may be transmitted to V2X modules for use in V2X applications of vehicles approaching, or in, or in proximity to a location associated with the rule. In some embodiments, a rule is transmitted to a V2X module that requests updated rules from the TRS for an area/location that the vehicle is entering. As indicated above, the rule may provide suggestions aimed at improving the accuracy of a V2X applications that receive the rule. The receiving V2X application may determine that the rule is applicable where one or more of the following factors match the ego vehicles current situation: location, time, ego-vehicle's state, and remote vehicles' states. Having determined that the rule is applicable, the V2X application may apply the rule, for example, by increasing or decreasing the CCT and CLT, to thereby reduce the likelihood of an FP/FN generated or suppressed alert and increase the likelihood of a TP generated or suppressed alert to thereby improve/enhance the accuracy of the V2X application.

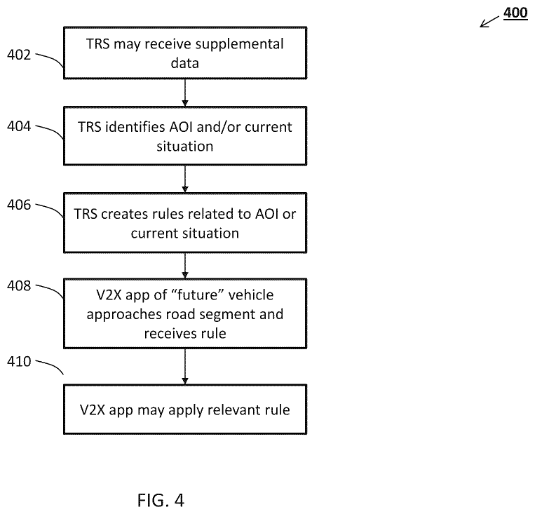

FIG. 4 illustrates a flow chart of a process 400 for enhancing the accuracy of V2X applications according to some implementations. In some embodiments, process 400 may be applied to V2X IMA application. In some embodiments, process 400 may be applied to other V2X applications. A non-transitory computer readable medium may contain instructions that when executed by at least one processor performs the method and operations described at each step as part of process 400. The non-transitory computer readable medium and at least one processor may correspond to TRS 110 and/or V2X module 104. Where process 400 refers to operation of a TRS or a V2X module, this should be understood as referring to operation of the components of TRS 110 or V2X module 104.

In step 402, the TRS may receive supplemental data available from non-V2X sources of data. Such supplemental data includes but is not limited to high-definition maps providing road and intersection layouts, that may include exact (lane level) positioning, road conditions/obstructions, real-time traffic data, weather, and visibility data. The Examples provided below illustrate use of such supplemental data.

In step 404, based on existing and/or supplemental data, the TRS may identify an area of interest such as an intersection, or a road segment with some physical characteristics that increases the likelihood for suppressed or generated alerts that are FPs or FNs (e.g., a curve with limited visibility). Alternatively or additionally, the TRS may identify a current situation such as a weather condition or increased traffic that increases the likelihood for suppressed or generated alerts that are FPs or FNs.

In step 406, rules may be defined by the TRS to eliminate or reduce FPs or FNs for vehicles approaching the analyzed location. As a non-limiting example, a rule may have the following structure/fields: Road segment identifier (or other location identifier), time range in which this rule should be applied, vehicle states for the ego and relevant RVs, suggested action i.e.: issue or suppress predicted collision alert, increase/decrease CCT to change the sensitivity level of alert generation, and/or increase/decrease CLT to change the lead time for collision detection. The ‘suggested action’ field in the rule may serve as a suggestion to a V2X application that has received the rule on an ego-vehicle approaching, or in proximity to the rule location, and may cause the receiving V2X application to generate or suppress an alert.

In step 408 the relevant rules, generated in step 406, may be transmitted to V2X modules for use in V2X applications of vehicles approaching or in a designated area associated with the rule. In some embodiments, a rule is transmitted to a V2X module that requests updated rules from the TRS for a location that the vehicle is entering or in the proximity of. As indicated above, the rule may provide suggestions aimed at improving the accuracy of a V2X application receiving the rule.

In step 410, the receiving V2X application may determine that the rule is applicable where one or more of the following factors match the ego vehicle's current situation: location, time, ego-vehicle's state, and remote vehicles' states. Having determined that the rule is applicable, the V2X application may apply the rule, for example, by increasing or decreasing the CCT and CLT, to thereby reduce the likelihood of an FP/FN generated or suppressed alert and increase the likelihood of a TP generated or suppressed alert to thereby improve/enhance the accuracy of the V2X application.

The following examples illustrate potential use cases for the systems and method described hereinabove.

### Example 1

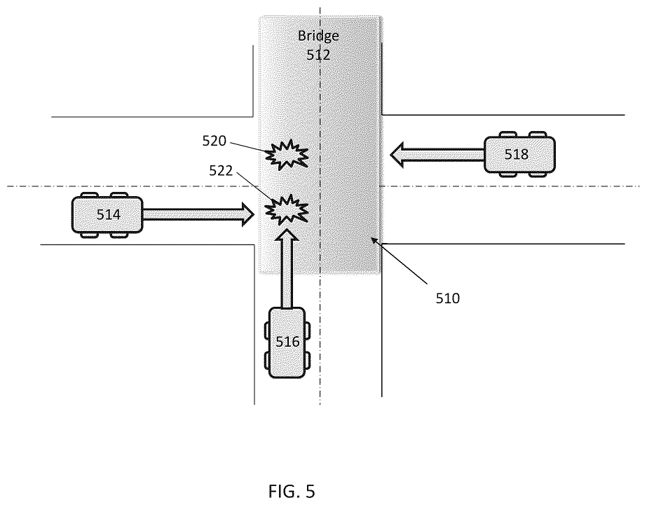

FIG. 5 is an illustration of an exemplary road intersection 510 where V2X applications may be enhanced according to some embodiments. As shown in FIG. 5, an intersection 510 includes a bridge/overpass 512 for one direction of traffic such that there is no danger of crossing vehicles actually colliding with one another. Vehicles 514, 516, and 518 are shown approaching intersection 510. Processes 200/300 may be applied to the intersection 510 using, for example, TRS 110 and V2X modules installed in each of vehicles 514, 516, and 518 (such as V2X modules 104 described above) where the V2X modules 104 and TRS 110 are in communication with one another.

In step 201, the V2X applications in vehicles 514, 516, and 518 performs their intended function, monitoring data from the ego and other vehicles and each determining that an alert should be issued for a predicted collision, for example at points 520 or 522. In practice, no collision will take place due to bridge 512 separating the crossing traffic. In step 202, event data relating to the issued alerts from the V2X applications in vehicles 514, 516, and 518 may be collected and stored by the TRS.

In step 204 the collected event data may be analyzed by the TRS in order to identify FPs issued for this particular location and also to identify an FP alert pattern. The analysis may identify FPs as alerts that were generated but did not result in any adverse consequences, since the vehicles passed over/under one another due to the presence of bridge 512.

In step 206 rules may be defined by the TRS to eliminate or reduce such FPs under sufficiently similar circumstances for vehicles arriving at the same location in the future. For example, based on the analysis of step 204 the CCT would be significantly increased so that alerts would not be generated at all for similar crossing traffic passing through intersection 510.

In step 208 the relevant rules, generated in step 206, may be transmitted by the TRS to vehicles approaching or present in a designated area (road segments leading to intersection 510) associated with the rule. In step 210 a V2X application that has received the rules on an ego-vehicle that is approaching intersection 510, may determine that its current situation (position, time, ego vehicle state, RV states) is sufficiently similar to that of the rule and may adapt its behavior according to the rule. The V2X application may then set the CCT and CLT to the values defined in the rule and suppress alerts that predict collisions of crossing traffic in intersection 510 accordingly.

### Example 2

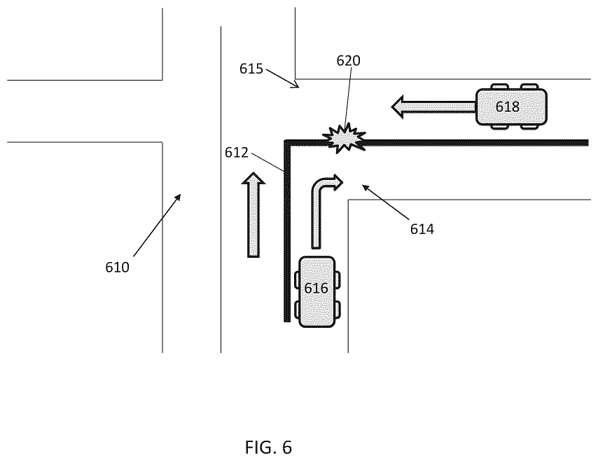

FIG. 6 is an illustration of an exemplary road intersection where V2X applications may be enhanced according to some embodiments. As shown in FIG. 6, an intersection 610 includes a right-turn lane 614 with a physical barrier 612 preventing collisions with traffic using lane 615. Vehicles 616 and 618 are shown approaching intersection 610. Process 400 may be applied to the intersection 610 for V2X applications using, for example, TRS 110 and V2X modules installed in each of vehicles 616 and 618 (such as V2X modules 104 described above) where the V2X modules 104 and TRS 110 are in communication with one another.

In step 404 supplementary data may be analyzed such as analysis of high-definition road maps available to the TRS (such as received from an external high-definition maps service in step 402).

In step 406 rules may be defined by the TRS to eliminate or reduce FPs that might be generated for vehicles arriving in lanes 614 and 615. For example, based on the analysis of step 404 the CCT would be significantly increased so that alerts would not be generated at all for vehicles that are prevented from contact by barrier 612.

In step 408 the relevant rules, generated in step 406, may be transmitted by the TRS to vehicles approaching or present in a designated area (lanes 614, 615) associated with the rule. In step 410 a V2X application that has received the rules on an ego-vehicle that is approaching lanes 614 or 615, may determine that its current situation (position, time, ego vehicle state, RV states) is sufficiently similar to that of the rule and may adapt its behavior according to the rule. The V2X application may then set the CCT and CLT to the values defined in the rule and suppress alerts that predict collisions of crossing traffic in intersection 610 accordingly.

### Example 3

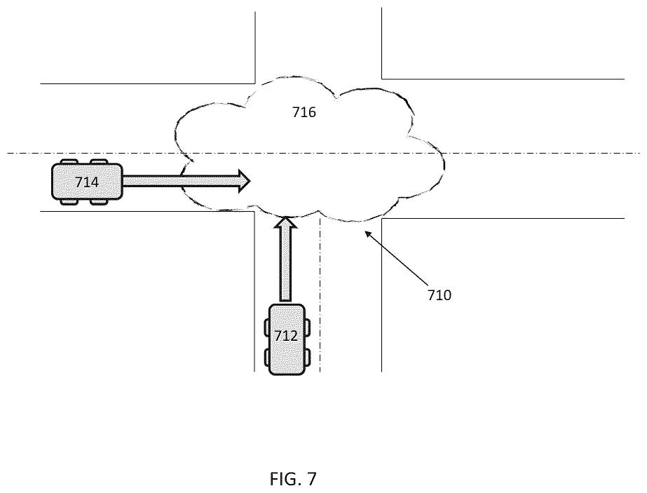

FIG. 7 is an illustration of an exemplary road intersection where V2X applications may be enhanced according to some embodiments. As shown in FIG. 7, vehicles 712, and 714 are shown approaching intersection 710. Processes 200/300 may be applied to the intersection 710 for V2X applications using, for example, TRS 110 and V2X modules installed in each of vehicles 712 and 714 (such as V2X modules 104 described above) where the V2X modules 104 and TRS 110 are in communication with one another.

In step 201, the V2X applications in vehicles 712 and 714 perform their intended function, monitoring data from the ego and other vehicles and each determining that an alert should be suppressed for a predicted collision between vehicles 712 and 714 due to a low CCT. In practice, due to wet road conditions and puddles 716, vehicles 712 and 714 take longer to slow down at intersection 710 and the drivers may be forced to take evasive action to prevent a collision. In step 202, event data relating to the suppressed alerts from the V2X applications in vehicles 712 and 714 may be collected and stored by the TRS.

In step 204 the collected event data may be analyzed by the TRS in order to identify FNs issued for this particular location and also to identify an FN alert pattern. The analysis may identify FNs as alerts that were suppressed but one or more of the following occurred: a collision, an alert generated by other sensors (such as but not limited to cameras or radar that are in communication with the V2X module), and/or harsh, preventive actions taken by drivers. An FN in this case may also include a late V2X alert that did not allow the driver ample time to react safely due to the wet road. The TRS may access data relating to weather conditions (such as from a weather data service) and determine that such FNs are more likely to happen at intersection 710 following periods of wet weather. Alternatively or additionally, the TRS may determine based on event data from the vehicles, that the vehicle behavior was related to wet road conditions, such as activation of anti-lock braking systems (ABS).

In step 206 rules may be defined by the TRS to eliminate or reduce such FNs under sufficiently similar circumstances for vehicles arriving at intersection 710 in wet weather conditions in the future such as where TRS receives data about pending rain, or when rain has already fallen in the area of intersection 710. For example, the CCT may be reduced during wet weather and/or the CLT may be increased to give drivers more time to react to an alert to thereby decrease the occurrence of FNs.

In step 208 the relevant rules, generated in step 206, may be transmitted by the TRS to vehicles approaching or present in a designated area (intersection 710). In some embodiments, the TRS may only transmit the “wet weather” rule when current weather conditions match those associated with the rule. In step 210 a V2X application that has received the rules on an ego-vehicle that is approaching intersection 710, may determine that its current situation (position, time, ego vehicle state, RV states) is sufficiently similar to that of the rule and may adapt its behavior according to the rule. The V2X application may then set the CCT and CLT to the values defined in the rule and provide alerts that predict collisions of crossing traffic in intersection 710 accordingly.

Alternatively, process 400 may be applied to the example of intersection 710. In step 404, supplementary data may be analyzed such as weather data available to the TRS (such as received from an external weather service in step 402).

In step 406, rules may be defined by the TRS to eliminate or reduce FNs that might be generated for vehicles arriving at intersection 710 in wet weather. For example, based on the analysis of step 404 the CLT might be increased so that alerts would be generated so as to give drivers time to respond when intersection 710 is wet.

In step 408 the relevant rules, generated in step 406, may be transmitted by the TRS to vehicles approaching intersection 710 when the TRS has determined based on weather data that intersection 710 may be wet. A V2X application that has received the rules on an ego-vehicle that is approaching intersection 710, may determine that its current situation (position, time, ego vehicle state, RV states) is sufficiently similar to that of the rule and may adapt its behavior according to the rule.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a processor chip or a circuit. As software or algorithm, selected steps of the disclosure could be implemented as a plurality of software instructions being executed by a computer/processor using any suitable operating system. In any case, selected steps of the method and system of the disclosure could be described as being performed by a data processor, such as a computing device for executing a plurality of instructions.

Various implementations of the systems and techniques described here can be realized in digital electronic circuitry, integrated circuitry, specially designed ASIC s (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally comprise a “network” or a “computer network”.

To provide for interaction with a user, the systems and techniques described here can be implemented on a computing device having a display (indicator/monitor/screen/array) (such as a LED (light-emitting diode), OLED (organic LED), LCD (liquid crystal display) or other display technology) for displaying information to the user and a keyboard and a pointing device (e.g., a mouse, joystick or a trackball) or individual buttons/knobs/levers (such as driving wheel buttons/signaling levers) by which the user can provide input to the computing device. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, analysis of user head position and/or eye movements, or tactile input.

It should be appreciated that the above-described methods and apparatus may be varied in many ways, including omitting, or adding steps, changing the order of steps and the type of devices used. It should be appreciated that different features may be combined in different ways. In particular, not all the features shown above in a particular embodiment or implementation are necessary in every embodiment or implementation of the disclosure. Further combinations of the above features and implementations are also considered to be within the scope of some embodiments or implementations of the disclosure.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations and embodiments described.

What is claimed is:

1. A system, comprising:
a vehicle-to-everything (V2X) module installed in a vehicle and including a V2X application running thereon wherein the V2X application is configured to generate or suppress an alert; and
a traffic rule server (TRS) in data communication with the V2X module,
wherein the TRS is configured to collect event data from the V2X module related to the generated or suppressed alert, to determine whether the generated or suppressed alert was a false positive (FP), false negative (FN), or true positive (TP) alert, and to create a rule for use in a V2X application receiving the rule, the rule used for reducing FP and FN alerts generated or suppressed by the V2X application receiving the rule.

2. The system of claim 1, wherein the V2X application receiving the rule is configured to receive the rule from the TRS and to adjust its generation or suppression of an alert according to the rule.

3. The system of claim 1, wherein the rule includes a suggested collision confidence threshold (CCT) and/or a collision lead time (CLT).

4. The system of claim 1, wherein the rule relates to one or more of an event location, an event time, an ego vehicle state, or a remote vehicle states.

5. The system of claim 1, wherein the event data is selected from the group consisting of an event location, an event time, an ego vehicle state, a remote vehicle state, a V2X alert generated, a V2X alert suppressed, a collision confidence level (CCL), a CCT, and a combination thereof.

6. The system of claim 5, wherein the event data includes data from a time when the alert was generated or suppressed until one timeslot after a predicted collision time.

7. The system of claim 5, wherein the TRS is configured to determine whether a collision occurred and/or whether preventive measures were taken by a driver based on one or both of the ego and the remote vehicle states.

8. The system of claim 1, wherein the TRS is further configured to aggregate event data from a plurality of V2X applications according to an aggregation criteria.

9. The system of claim 8, wherein the aggregation criteria includes a location, a date, and/or a time.

10. The system of claim 8, wherein the TRS is further configured to supplement the aggregated event data with supplemental data, and wherein the supplemental data is selected from the group consisting of high-definition maps including road and intersections layouts with lane level positioning, road conditions/obstructions, traffic data, weather data, visibility data, and a combination thereof.

11. A method, comprising:
providing a vehicle-to-everything (V2X) module installed in a vehicle and including a V2X application running thereon, wherein the V2X application is configured to generate or suppress an alert;
providing a traffic rule server (TRS) in data communication with the V2X module; and
using the TRS to collect event data from the V2X module related to the generated or suppressed alert, to determine whether the generated or suppressed alert was a false positive (FP), false negative (FN), or true positive (TP) alert, and to create a rule for use in a V2X application receiving the rule, the rule used for reducing FP and FN alerts generated or suppressed by the V2X application receiving the rule.

12. The method of claim 11, wherein the rule relates to one or more of an event location, an event time, an ego vehicle state, or remote vehicle states.

13. The method of claim 11, further comprising, providing a V2X application configured to receive the rule from the TRS and to adjust its generation or suppression of an alert according to the rule.

14. The method of claim 11, wherein the rule includes a suggested collision confidence threshold (CCT) and/or a collision lead time (CLT).

15. The method of claim 11, wherein the event data is selected from the group consisting of an event location, an event time, an ego vehicle state, a remote vehicle state, a V2X alert generated, a V2X alert suppressed, a collision confidence level (CCL), a CCT, and a combination thereof.

16. The method of claim 11, wherein the event data includes data from a time when the alert was generated or suppressed, until one timeslot after a predicted collision time.

17. The method of claim 11, wherein the TRS is further configured to aggregate event data from a plurality of V2X applications according to an aggregation criteria, and wherein the aggregation criteria includes a location, a date, and/or a time.

18. The method of claim 17, wherein the TRS is further configured to supplement the aggregated event data with supplemental data, and wherein the supplemental data is selected from the group of high-definition maps including road and intersections layouts with lane level positioning, road conditions/obstructions, traffic data, weather, visibility data, and a combination thereof.

19. A system, comprising a traffic rule server (TRS) configured to analyze road and/or environmental data at a location and to create a rule for use in a vehicle-to-everything (V2X) application receiving the rule, the rule used for reducing FP and FN alerts generated or suppressed in the proximity of the location by the V2X application receiving the rule.

20. The system of claim 19, wherein road data includes high-definition maps including road and intersections layouts with lane level positioning, and environmental data is selected from the group consisting of road conditions/obstructions, traffic data, weather, visibility data, and a combination thereof.

21. The system of claim 19, wherein the V2X application receiving the rule is configured to receive the rule from the TRS and to adjust its generation or suppression of an alert according to the rule.

22. A method comprising:
providing a traffic rule server (TRS); and
using the TRS to analyze road and environmental data at a location and to create a rule for use in a vehicle-to-everything (V2X) application receiving the rule, the rule used for reducing FP and FN alerts generated or suppressed in the proximity of the location by the V2X application receiving the rule.

23. The method of claim 22, wherein road data includes high-definition maps including road and intersections layouts with lane level positioning, and environmental data is selected from the group consisting of road conditions/obstructions, traffic data, weather, visibility data, and a combination thereof.

24. The method of claim 22, further comprising, providing a V2X application configured to receive the rule from the TRS, and to adjust its generation or suppression of an alert according to the rule.
